(19) United States
(12) Patent Application Publication
(10) Pub. No.: US 2026/0151791 A1
(43) Pub. Date: Jun. 4, 2026

(54) METHOD FOR COATING A WHEEL HUB ASSEMBLY

(71) Applicant: AKTIEBOLAGET SKF, GOTEBORG (SE)

(72) Inventors: Marco ROMANETTO, Pianezza (IT); Piero BALLARI, Vigone (IT)

(21) Appl. No.: 19/399,771

(22) Filed: Nov. 25, 2025

(30) Foreign Application Priority Data
Dec. 3, 2024 (IT) 102024000027396

(51) Int. Cl. B05D 1/12; B05D 1/32; B05D 3/02; B05D 1/00

(52) U.S. Cl. CPC B05D 1/12; B05D 1/32; B05D 3/0263; B05D 1/002

(57) ABSTRACT

A method includes mounting an assembled wheel hub assembly ₒₙ a spindle, spraying a zinc flake coating material onto first surfaces of the assembly while rotating the wheel hub assembly, the spraying occurring while shielding second surfaces of the wheel hub assembly with a shield on the spindle and shielding third surfaces of the wheel hub assembly using a shielding tape. After creating the layer of zinc flake coating material on the first surfaces, heating the layer of zinc flake coating material using at least one infrared (IR) lamp to cure the layer of zinc flake coating material, the heating occurring while rotating the wheel hub assembly.

### CROSS-REFERENCE

This application claims priority to Italian patent application no. 102024000027396 filed on December 3, 2024, the contents of which are fully incorporated herein by reference.

### TECHNOLOGICAL FIELD

The present disclosure relates to a method for coating exposed surfaces of a wheel hub assembly for vehicles. The disclosure also relates to an associated wheel hub assembly having an anti-corrosion protective layer applied to specific exposed surfaces thereof.

### BACKGROUND

It is known that suspensions for vehicles, in particular motor vehicles, are provided with wheel hub assemblies for rotatably supporting the vehicle wheels. A wheel hub assembly comprises, or is formed of, a rolling bearing, in which inner and outer rings are attached to respective mounting flanges, a first flange configured to receive a vehicle wheel and a second flange to enable fastening of the wheel hub assembly to a vehicle suspension upright.

In modern wheel hub assemblies, the inner and outer rings of the rolling bearing are provided directly, in one piece, with the aforementioned first and second flange, and generally the first flange for wheel support is formed integrally with the inner ring or a component thereof constituting a spindle, and the second flange for mounting on the vehicle suspension is formed integrally with the outer ring, radially on the outside thereof. Especially the second flange and exposed parts of the rolling bearing in the vicinity thereof can be subjected in use to corrosion.

WO 2019/015712 (family member of US 11,098,756) discloses a method for fully coating a wheel hub assembly with a zinc flake coating in which all the exposed surfaces, namely those facing radially outwards, of the components of the wheel hub assembly, such as at least part of the radially outer lateral surfaces of the inner and outer rings and the respective flanges, are covered with a zinc flake coating by spraying or immersion in a suitable bath, with subsequent hardening (curing) by treatment in a convection oven. According to WO 2019/015712, curing is carried out at a hardening temperature of at least 15°C and at most 80°C for a hardening time of at least 10 minutes, but usually close to 16 minutes. Any parts of the wheel hub assembly that are not to be coated have to be masked, for example covered with a protective tape.

More generally, zinc flake coatings are well known in the art, particularly for coating large structures and fasteners. In particular, the specifications for zinc flake coatings are defined in international standard ISO 10683 (e.g., ISO 10683:2018) and also in European standard EN 13858 (e.g., EN 13858-2008). Standard ISO 10683 sets out the requirements for zinc flake coatings for threaded fastening elements and standard EN 13858 describes the requirements for zinc flake coatings for fastening elements without a thread.

To sum up, the process according to WO 2019/015712 requires at least 10 minutes for each wheel hub assembly in order to ensure that the applied coating dries and hardens fully and provide a coating with a thickness of between 10 and 20 microns, greater thicknesses being subject to cracking.

Furthermore, the use of convection ovens, for example tunnel ovens, requires a lot of energy and large installations, entailing high costs. The thermal energy provided for achieving the necessary temperatures in the zinc flake coating is then also transmitted inside the wheel hub assembly, with possible criticalities in the lubricants applied between the rings of the rolling bearing for lubrication of the rolling elements and on the sealing gaskets.

### SUMMARY

The present disclosure provides a method for coating exposed surfaces of a wheel hub assembly which does not have the drawbacks described above and which makes it possible to obtain zinc flake coatings on components that are sensitive to heat damage, such as wheel hub assemblies, with reduced energy consumption, reduced installation sizes, good thickness of the coating and reduced curing times, all using zinc flake coating products of commercial type, namely the type of those used for fasteners and other applications.

The disclosure also provides an associated wheel hub assembly having a zinc flake coating obtained according to the method above, which can be implemented in an associated installation.

Here and below, "exposed surfaces" are understood to mean parts facing towards the outside of the wheel hub assembly, such as radially outer lateral surfaces of the inner and outer rings of a rolling bearing of a wheel hub assembly and the outer surfaces of respective mounting flanges of the wheel hub assembly.

### BRIEF DESCRIPTION OF THE DRAWINGS

The disclosure will now be described with reference to the attached drawings, which illustrate a non-limiting example embodiment thereof, in which:

FIG. 1 is a schematic side elevational view, partly in section, of a wheel hub assembly mounted on a shaft in a cantilevered manner and to which a coating is being applied according to a first step of a method of the present disclosure.

FIG. 2 is a schematic side elevational view, partly in section, of the wheel hub assembly of FIG. 1 on during a heating step of the method of the present disclosure.

FIG. 3 is a schematic end elevational view of a portion of the wheel hub assembly of FIG. 1 showing the location of a shielding tape that shields a portion of the wheel hub assembly during the method of the present disclosure.

### DETAILED DESCRIPTION

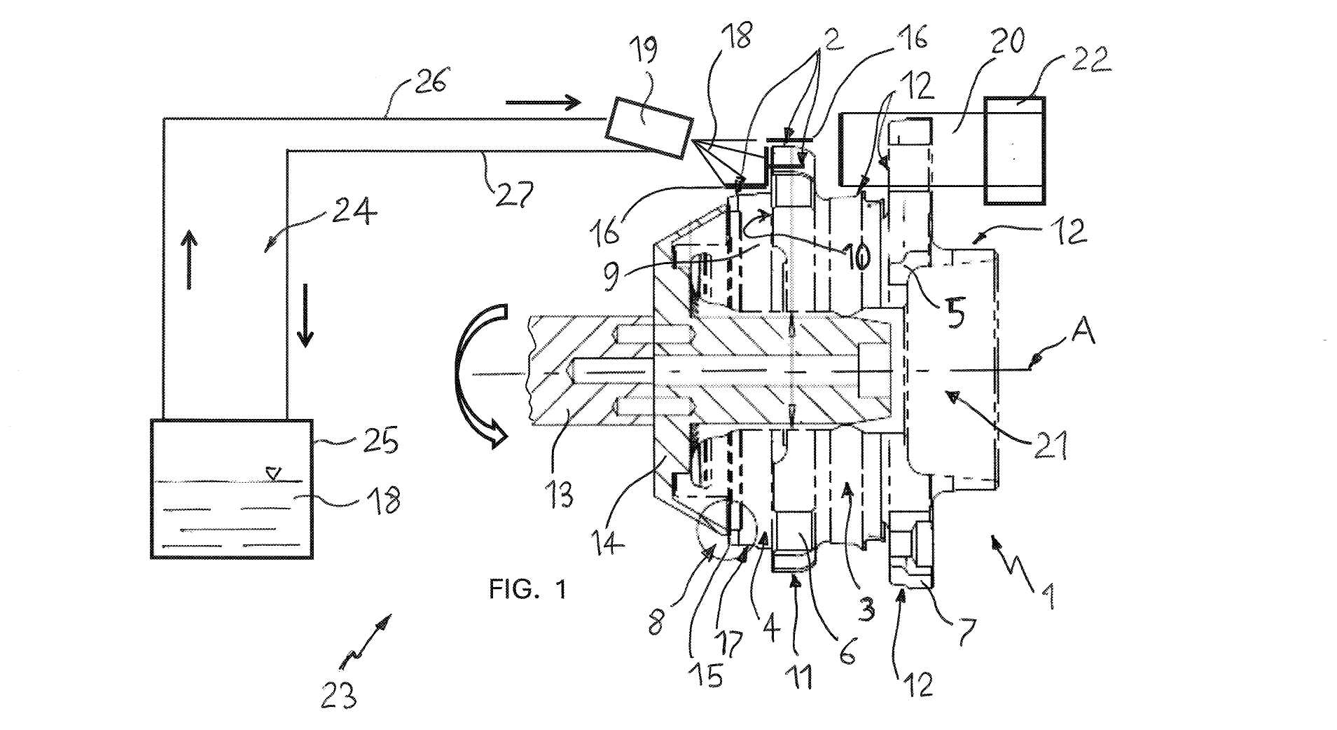

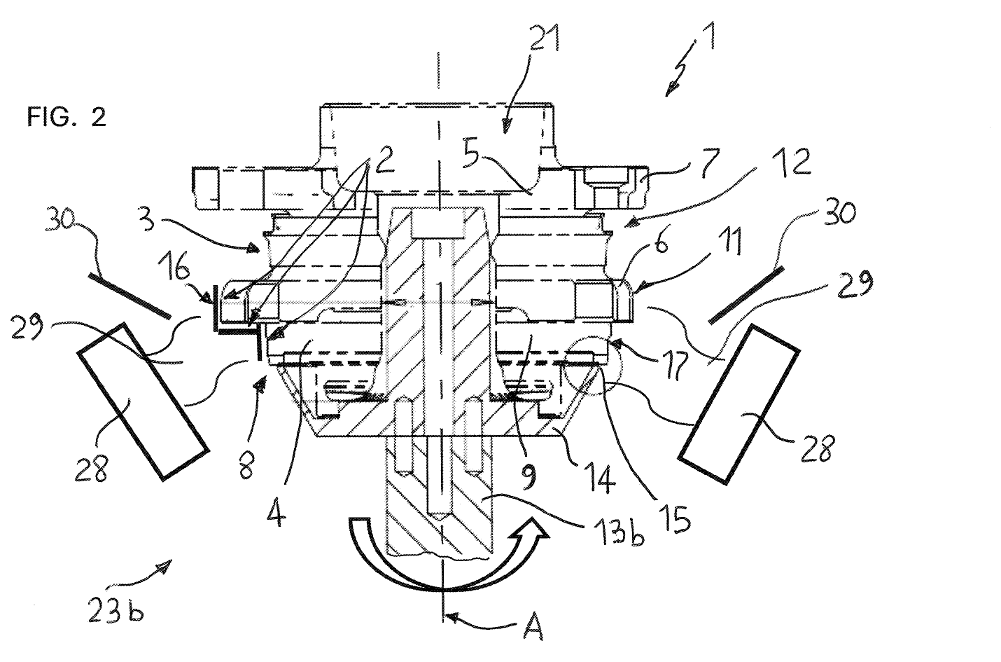

FIGS. 1 and 2 schematically illustrate two steps of a method for coating exposed surfaces 2 of a wheel hub assembly 1 comprising, or formed of, a rolling bearing 3 in turn comprising an outer ring 4 and an inner ring 5, which are configured to be relatively rotatable by means of known rolling elements which are interposed between them and not illustrated for the sake of simplicity. The wheel hub assembly 1 further comprises a first mounting flange 6 rigidly attached to the outer ring 4 and a second mounting flange 7 rigidly attached to the inner ring 5.

In the non-limiting example illustrated, the rolling bearing 3 constitutes the entire wheel hub assembly 1, and the first and second flanges 6 and 7 are formed integrally with the outer and inner rings 4 and 5, radially on the outside thereof.

In other possible embodiments, which are not illustrated for the sake of simplicity, the flanges 6 and 7 are attached to the rings 4 and 5 indirectly, by means of other components of the wheel hub assembly 1 which are known per se, for example the inner ring 5 may be fitted on a spindle provided with the flange 7 at an end thereof.

The flange 6 is adjacent to a first end 8 of the wheel hub assembly 1 which first end 8 comprises a sleeve-shaped end portion 9 of the outer ring 4 that projects axially from the flange 6.

In the preferred embodiment illustrated, the first exposed surfaces 2 include at least an axially facing front surface 10 and a radially outer peripheral edge 11 of the first flange 6.

The wheel hub assembly 1 further comprises second exposed surfaces, indicated as a whole by 12, generally comprising the outer surfaces of the flange 7 and the lateral surfaces of the rings 4 and 5, in this case excluding the radially outer lateral surface of the sleeve-like end 9 of the outer ring 4 which forms part of the first exposed surfaces 2 which, according to the method of the disclosure, have to be protected, for example by increasing the corrosion resistance thereof.

First of all, the exposed surfaces 2 to be protected or even all the outer exposed surfaces 2 and 12 of the wheel hub assembly 1 have to be treated with a cleaning agent (which is known and not illustrated for the sake of simplicity) in order to remove any small traces of oil, grease or other contaminants present on the exposed surfaces 2 and 12 as a result of the various machining and mounting steps.

The cleaning agent is preferably a solvent containing a detergent fluid. Solvents containing detergent fluids are characterized by rapid action, good material compatibility and simple applicability. Therefore, the cleaning agent does not react with the surfaces 2 to be treated, or the material of the wheel hub assembly 1. The cleaning agent is preferably sprayed on the surfaces of the components to be treated, it also being conceivable for the cleaning agent to be applied manually to the wheel hub assembly 1.

After the cleaning agent has been applied to the surfaces 2 of the components to be treated, the wheel hub assembly 1 is spun at high speed, in such a way that the excess cleaning agent is removed by the centrifugal force occurring on the surfaces 2 of the components.

After this preliminary step and with reference to FIG. 1, according to the method of the disclosure, a step of mounting, in a projecting manner, the already fully assembled wheel hub assembly 1, thus complete with internal lubricants and sealing gaskets, on a first motorized spindle 13 is carried out, fitting the wheel hub assembly 1 onto the first spindle 13 via the first flange 6 until the first end 8 of the wheel hub assembly 1 that is adjacent to the first flange 6 is brought against an annular screen 14, which has a cup-like concave shape and a frustoconical profile in the illustrated example and is mounted radially on the outside of the first spindle 13.

In this step, the wheel hub assembly 1 is fitted angularly and rigidly on the spindle 13, so as to be rotatable together with the latter. The screen 14 may also be fitted angularly and rigidly to the spindle 13, or be mounted radially on the outside thereof, but in a stationary manner, and thus remain still while the spindle 13, which is motorized and controlled, rotates together with the wheel hub assembly 1 as a whole. In both cases, as schematically indicated with a circle in FIG. 1, the annular screen 14 is separated from the sleeve-like end 9 of the outer ring 4 only by a very small axial gap 15, effectively creating a labyrinth seal between the screen 14 and the end 8 of the wheel hub assembly 1.

While the wheel hub assembly 1 is rotated about a common axis of symmetry A of the spindle 13 and of the wheel hub assembly 1, by the rotational activation of the spindle 13 at a predefined first speed, according to one aspect of the disclosure a step of applying a layer 16 of a zinc flake coating material 18 is carried out.

The layer 16 is schematically illustrated in FIG. 1 with a bold line and is deposited on all the first exposed surfaces 2 of the wheel hub assembly 1, the surfaces including, as already indicated, at least the front surface 10 and the radially outer peripheral edge 11 of the first flange 6.

This step of applying the zinc flake coating material 18, the material 18 being known and commercially available for other uses, in order to form the layer 16 is carried out, according to one aspect of the disclosure, by means of an air spray nozzle 19, the wheel hub assembly 1 being rotated by means of the spindle 13 about the axis A and the nozzle 19 being brought in front of the first exposed surfaces 2, all together or in sequence, at a predefined distance from the surfaces while the wheel hub assembly 1 is rotating.

The layer 16 of a zinc flake coating material 18 which is deposited on the first exposed surfaces 2 of the wheel hub assembly 1 is deposited not only on the front surface 10 and on the radially outer peripheral edge 11 of the first flange 6, but also on at least a radially outer surface 17 of the outer ring 4 that delimits the first end 8 of the wheel hub assembly 1 and thus forms an integral part of the first exposed surfaces 2.

According to one aspect of the disclosure, the second exposed surfaces 12 of the wheel hub assembly 1, which do not have to be coated with the material 18, are shielded from possible overspray by means of the annular screen 14 and by means of at least one shielding tape 20, as will be seen.

Indeed, the main drawback of the spray deposition of the material 18, which is mixed in the spray nozzle 19 or immediately upstream thereof with pressurized air in a known manner, is that it can create a spray "mist" around the exposed surfaces 2 which although on the one hand does allow uniform deposition of the material 18 to create the layer 16, on the other hand the sprayed material 18 not deposited on the surfaces 2 remains suspended in the ambient air and can be partially deposited randomly on the surfaces 12, in an undesired manner.

According to one aspect of the disclosure, the at least one shielding tape 20 is arranged stretched in a space axial between the first flange 6 and the second flange 7, to protect the second exposed surfaces 12 situated on the second flange 7 and at a second end 21 of the wheel hub assembly 1, opposite the first end 8.

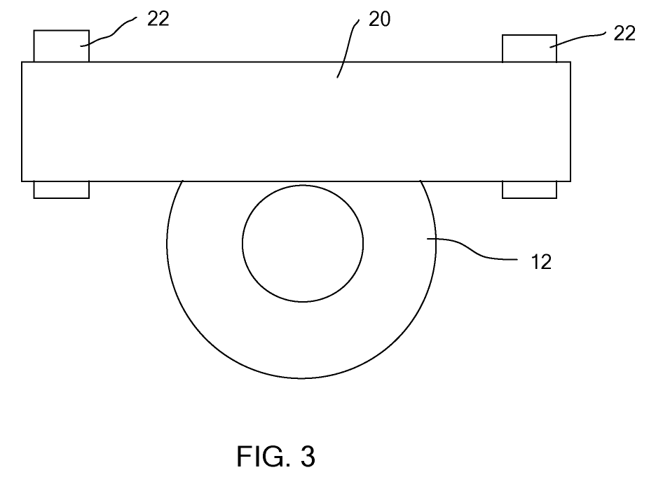

Preferably, the shielding tape 20 is unwound from, and wound onto, a pair of, for example motorized, rotatable spools 22, of which only one is illustrated in FIG. 1 because the spools 22 are arranged at diametrically opposite flanks of the first spindle 13, and therefore the second spool 22 is not visible as it is hidden by the first spool. The tape may follow a curved path between the first and second spools as suggested by the position of the tape 20 in FIG. 1 or, in the alternative, the portion of the tape 20 between the spools may lie substantially in a plane parallel to the plane of the exposed surface 12 as suggested by FIG. 3.

Although FIG. 1 illustrates the presence of a single shielding tape 20 supported by the spools 22, it is clear that it is possible, as needed, for more shielding tapes 20 (not illustrated for the sake of simplicity) to be provided which are oriented in different ways and configured to intercept all the material 18 that is oversprayed by the nozzle 19 and remains suspended in the atmospheric air.

In the non-limiting example embodiment illustrated in FIG. 1, the motorized spindle 13, the spools 22, the tape 20 and the nozzle 19 form part of a first processing station 23, also including a hydraulic circuit 24 connected to the nozzle 19 upstream and downstream thereof. The hydraulic circuit 24 comprises a tank 25 which includes or is associated with suitable circulation pumps (not illustrated for the sake of simplicity) and in which the material 18 is stored, a supply line 25 for the nozzle 19 and a recirculation line 27, in which the material 18 that has not been mixed with compressed air in the nozzle 19 and is conveyed back into the tank 25 flows.

Indeed, according to one aspect of the disclosure, the zinc flake coating material 18 is continuously recirculated within the hydraulic circuit 24 connected to the nozzle 19.

During this step of depositing/applying the material 18 on/to the surfaces 2 to form a layer 16, the first spindle 13 is rotated at between approximately 120 rpm and approximately 150 rpm, and the zinc flake coating material 18 is expelled from the nozzle 19 at an overpressure, with respect to the atmospheric pressure, of between approximately 0.45 bar and approximately 0.9 bar and, preferably, at a temperature of between 10°C and 40°C.

When the nozzle 19 is not in operation, the material 18 is still kept circulating within the hydraulic circuit 24, preferably at a pressure greater than the pressure at which the material 18 is dispensed from the nozzle 19.

Although the axis A is positioned horizontally in FIG. 1 for reasons of simplified representation, it is clear that the axis A of rotation of the spindle 13 can equally be horizontal or vertical. Each solution has its advantages and disadvantages, mainly depending on the density and viscosity of the zinc flake coating material 18, which can be added to the tank 25 with a diluent of the type suitable for varying the rheological properties thereof in a desired manner.

With reference now to FIG. 2, in which details similar or identical to those already described are indicated by the same reference numerals, a second processing station 23b is shown which is configured to carry out a subsequent step of the method of the disclosure, specifically the curing with related hardening of the layer 16 of material 18 that has just been deposited on the exposed surfaces 2.

Indeed, during the previous step of depositing the layer 16, the material 18 may be mixed with volatile solvents and, in particular, the composition of the zinc flake coating material 18 may involve, as is known, an organic or inorganic polymerizable base which is sensitive to temperature, in the sense that the material 18 hardens and dries more rapidly the higher the temperature to which it is brought after the layer 16 has been formed.

According to one aspect of the disclosure, and in combination with the foregoing, the step of curing the zinc flake coating material 18 deposited on the surfaces 2 to form a coating layer 16 thereof involves rotating the wheel hub assembly 1 about its axis of symmetry A after it has been mounted angularly and rigidly on, and coaxially with, the same spindle 13 or a second motorized spindle 13b (FIG. 2) that is substantially identical to the first spindle 13, and then heating solely by irradiation the exposed surfaces 2 by means of infrared (IR) lamps 28 while the wheel hub assembly 1 rotates at a predefined speed by virtue of the spindle 13 or 13b.

It should be noted that, to simplify the description and representation, the stations 23 and 23b are illustrated as two separate stations, forming part of the same installation configured to carry out the method of the disclosure. In reality, there may be a single station 23 which comprises a single spindle 13 and can be outfitted so as to selectively adopt both the configurations in FIG. 1 and FIG. 2.

Therefore, in this step, the wheel hub assembly 1 is also fitted angularly and rigidly on the same first spindle 13 (and remains fitted angularly and rigidly on the spindle 13 after the step in FIG. 1 has been carried out) or on an identical second spindle 13c, via the first flange 6, until the first end 8 of the wheel hub assembly 1 that is adjacent to the first flange 6 is brought against the same or another identical annular screen 14 which is mounted radially on the outside of the first or second annular spindle 13/13b and is thus identical to the one illustrated in FIG. 1.

The first exposed surfaces 2 are thus heated by irradiation by means of the IR lamps 28, the IR lamps 28 being brought in front of the first exposed surfaces 2, all together or in sequence, at a predefined distance from same, while the wheel hub assembly 1 is rotating, until the previously applied layer 16 of zinc flake coating material 18 is fully cured.

In the station 23b in FIG. 2, the axis A of rotation is shown in a vertical position to simplify the representation and description, but as in the case of the step shown in FIG. 1, it may equally be oriented horizontally or vertically.

During this step of curing by heating as well, the annular screen 14 is separated from the sleeve-like end 9 only by a very small axial gap 15, effectively creating a labyrinth seal between the screen 14 and the end 8 of the wheel hub assembly 1.

In the steps of depositing the zinc flake coating layer 16 and of curing same by localized heating, the nozzle 19 and the IR lamps 28 are brought in front of the first exposed surfaces 2, all together or in sequence one at a time, either by moving the nozzle 19 and the IR lamps 28 with respect to the first or second spindle 13/13b, for example by means of one or more robotized arms, or equally by moving the spindle 13 and/or 13b towards the nozzle 19 and/or the IR lamps 28.

For example, in one embodiment, the installation for carrying out the method of the disclosure comprises one station 13, or a plurality of stations 13 which operate in parallel, served by robotized arms which bear the nozzle 19 and the lamps 28. In a different embodiment, a plurality of identical spindles 13 are mounted on a rotary table which transfers each spindle 13 through a plurality of stations, for example for mounting and removing the wheel hub assembly 1 on/from a spindle 13, a station for depositing the layer 16 provided with at least one nozzle 19 in a position that is fixed or movable by means of a robotized system, and one or more curing stations which are all provided with IR lamps 28 and along which the spindles 13 pass in order to finish the procedure for heating and hardening the layer 16 on each wheel hub assembly 1.

In any case, the curing step is carried out for a duration of not more than 480 seconds, preferably for a duration of 360 seconds, using at least one pair of IR lamps per station 23/23b which have a power of approximately 3000 watts and are arranged opposite the first exposed surfaces 2.

In any case, the curing step, independently of whether it is effected in the same station or through multiple stations 23/23b, is carried out by rotating the wheel hub assembly 1 about its axis of symmetry A by means of the first or second spindle 13/13b at a speed of approximately 60 rpm, that is to say slower than the speed used in the step of applying the layer 16.

According to one aspect of the disclosure, during the step of curing by localized heating of the exposed surfaces 2 alone, the entire wheel hub assembly 1, except for the first exposed surfaces 2, is shielded from beams 29 of IR (infrared) radiation of short or medium wavelength emitted by the IR lamps 28 by means of the annular screen 14, which thus has a dual function (protection from overspray and from radiation 29), and by heat shields 30 arranged between the IR lamps 28 and the second exposed surfaces 12 of the wheel hub assembly 1. The heat shields 30 are preferably attached laterally and rigidly to the IR lamps 28, so as to be able to be moved therewith.

Comparative experimental tests carried out by the applicant have demonstrated that the method of the disclosure makes it possible to bring the zinc flake coating layers 16 previously deposited on the surfaces 2 to a temperature of 120° C in a very short period of time, not more than 480 seconds (approximately 8 minutes) and on average 360 seconds (6 minutes), obtaining full curing of the layers 16 and ensuring an internal temperature of the wheel hub assembly 1 of not more than 60-80°C, generally of less than 60° C. In contrast, optimal results in terms of resistance and sealing of the cured layers 16 are obtained, even if the latter have a thickness greater than 20 microns, up to thicknesses of approximately 35 microns, making it possible to obtain optimal protection of the exposed surfaces 2 treated.

It is lastly clear from the foregoing that the disclosure also relates to a wheel hub assembly 1 for motor vehicles, comprising a rolling bearing 3 in turn comprising an outer ring 4 and an inner ring 5, which are rotatable relative to one another, and a respective first and second mounting flange 6, 7 which are rigidly attached, directly or indirectly, radially on the outside, to the outer ring 4 and the inner ring 5 respectively, wherein first exposed surfaces 2 of the wheel hub assembly 1, including at least a front surface 10 and a radially outer peripheral edge 11 of the first flange 6 (and preferably also the surface 17), are coated with a layer 16 of a zinc flake coating material which has been produced by the coating method described and has a radial thickness of between 9 and 35 microns, without any cracking whatsoever.

By virtue of the method described, it is clear that what is obtained is a cycle time lower than those in the prior art and better drying of the thickness of the film layer made of zinc flake coating material 18 up to the high value of 35 µm.

Furthermore, the footprint of the installation required for effecting the method of the disclosure is greatly reduced, limited to the size of the spindle 13, considering that the stations 23 and 23b may be a single station, and of the systems for supporting and controlling the spray nozzle 19 and the IR lamps 28, which may consist of the same spindle 13 in a single complete station 23, outfitted both with the nozzle 19 and with the lamps 28 with the shields 30.

The internal temperature of the wheel hub unit 1 is lastly kept within relatively low values that do not pose a risk of possible damage. All of the objectives of the disclosure are thus achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved wheel coating methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method comprising:
providing an assembled wheel hub assembly comprising a rolling bearing, the rolling bearing including an outer ring having a first mounting flange and an inner ring having a second mounting flange and a center opening,
providing a first spindle having a radially extending annular screen, the first spindle having a free end,
inserting a free end of the first spindle into the center opening of the assembled wheel hub assembly until an axial end of the wheel hub contacts or is located within a first predetermined distance of the screen,
rotating the assembled wheel hub assembly at a second predetermined distance from an air spray nozzle,
spraying a zinc flake coating material, using the air spray nozzle, onto at least one axially facing front surface of the first flange and onto a radially facing outer peripheral edge of the first flange to create a layer of the zinc flake coating material while rotating the wheel hub assembly, wherein the air spray nozzle and the screen are positioned such that the screen prevents the layer of zinc flake coating material from forming on at least a first protected portion of the wheel hub assembly,
positioning a shielding tape between the air spray nozzle and a second protected portion of the assembled wheel hub assembly, and
after creating the layer of zinc flake coating material on the at least one axially facing front surface of the first flange and on the radially facing outer peripheral edge of the first flange, heating the layer of zinc flake coating material using at least one infrared (IR) lamp to cure the layer of zinc flake coating material, the heating occurring while rotating the assembled wheel hub assembly.

2. The method according to claim 1,
wherein the heating is performed for a duration of not more than 480 seconds, and
wherein the at least one IR lamp comprises a pair of 3000 watt IR lamps directed at circumferentially spaced portions of the first flange.

3. The method according to claim 1,
wherein the heating is performed for a duration of not more than 360 seconds, and
wherein the at least one IR lamp comprises a pair of 3000 watt IR lamps directed at circumferentially spaced portions of the first flange.

4. The method according to claim 1,
wherein the assembled wheel hub assembly is rotated around an axis of symmetry of the assembled wheel hub assembly during the heating at 60 rpm.

5. The method according to claim 1,
including spraying the zinc flake coating material onto an additional surface of the assembled wheel hub assembly.

6. The method according to claim 1,
wherein the shielding tape is supported between a first spool and a second spool, and
including winding the shielding tape from the first spool to the second spool during the spraying.

7. The method according to claim 1,
wherein the assembled wheel hub assembly is rotated around an axis of symmetry of the assembled wheel hub assembly during the spraying at 120 to 150 rpm.

8. The method according to claim 7,
wherein the spraying includes ejecting the zinc flake coating material from the air spray nozzle at an overpressure, with respect to atmospheric pressure, between 0.45 bar and 0.9 bar and at a temperature between 10°C and 40°C;

9. The method according to claim 8,
including continuously recirculating the zinc flake coating material within a hydraulic circuit during the spraying.

10. The method according to claim 1,
wherein the assembled wheel hub assembly is rotated around an axis of symmetry of the assembled wheel hub assembly during the spraying at 120 to 150 rpm, and
wherein the assembled wheel hub assembly is rotated around the axis of symmetry of the assembled wheel hub assembly during the heating at 60 rpm.

11. The method according to claim 1,
including positioning heat shields to shield portions of the assembled wheel bearing assembly other than the at least one axially facing front surface of the first flange and the radially facing outer peripheral edge of the first flange, from infrared radiation emitted from the IR lamps.

12. The method according to claim 1,
including positioning heat shields to shield all portions of the assembled wheel bearing assembly other than the at least one axially facing front surface of the first flange and the radially facing outer peripheral edge of the first flange and the additional surface of the assembled where hub assembly, from infrared radiation emitted from the IR lamps.

13. The method according to claim 1,
wherein a thickness of the layer of zinc flake coting material is 9 microns to 35 microns after the heating.

14. The method according to claim 1,
including winding the shielding tape from the first spool to the second spool during the spraying,
wherein the heating is performed for a duration of not more than 360 seconds,
wherein the at least one IR lamp comprises a pair of 3000 watt IR lamps directed at circumferentially spaced portions of the first flange,
wherein the spraying comprises ejecting the zinc flake coating material from the air spray nozzle at an overpressure, with respect to atmospheric pressure, between 0.45 bar and 0.9 bar and at a temperature between 10°C and 40°C,
wherein the assembled wheel hub assembly is rotated around an axis of symmetry of the assembled wheel hub assembly during the spraying at 120 to 150 rpm, and
wherein the assembled wheel hub assembly is rotated around the axis of symmetry of the assembled wheel hub assembly during the heating at 60 rpm.

15. A wheel hub assembly produced by a method according to claim 14.

16. A wheel hub assembly produced by a method according to claim 1.
